(19) United States
(12) Patent Application Publication
(10) Pub. No.: US 2008/0110345 A1
(43) Pub. Date: May 15, 2008

(54) ELECTRONIC DEVICE CAPABLE OF DETECTING THE TIMING FOR REPLACING A FILTER

(76) Inventors: Shun-Chieh Yang, Taipei County (TW); Chun-Ming Shen, Taipei County (TW); Chieh-Fu Chen, Taipei County (TW)

Correspondence Address: NORTH AMERICA INTELLECTUAL PROPERTY CORPORATION, P.O. BOX 506, MERRIFIELD, VA, 22116, US

(21) Appl. No.: 11/875,956

(22) Filed: Oct. 22, 2007

(30) Foreign Application Priority Data
Nov. 9, 2006 (TW) 095141501

(51) Int. Cl. B01D 50/00

(52) U.S. Cl. 96/418

(57) ABSTRACT

An electronic device includes a housing comprising a vent, and a filter installed nearby the vent. The filter includes a first filter section made of a first material, and a second filter section made of a second material. The first material has better uniformity than the second material. The electronic device further includes a light emitter for emitting a light signal to the first filter section, a light receiver for receiving the light signal emitted from the light emitter, and a control unit electrically connected to the light receiver for operating the electronic device according to a receiving result of the light signal received by the light receiver.

### BACKGROUND OF THE INVENTION

1. Field of the Invention

The present invention relates to an electronic device capable of detecting the timing for replacing a filter, and more particularly, to an electronic device capable of detecting the timing for replacing a filter according to a sensing result of a light receiver.

2. Description of the Prior Art

Projectors are conventionally used in conference briefings in which a host projects data or graphics onto a screen for familiarizing attendants with a presentation. With the rapid development of technology, projectors have been widely used in other applications. With high-power hi-fi equipment, large-capacity digital video discs (DVDs), and large images generated by a projector, it is now possible to reconstruct at home visual and audio effects similar to those provided in a movie theater.

The projector generates heat at work, such as heat generated by lamps, so there is a vent disposed on the projector for discharging heat out of the projector. There is also a filter installed nearby the vent for preventing dust from getting into the projector. However, when the filter is choked with dust, cooling efficiency is reduced and the temperature inside the projector rises. Therefore, it is necessary to clean or replace the filter regularly to keep airflow unhindered. A conventional method to replace the filter in the projector is regularly reminding users the used hours of the projector. However, the used hours of the projector cannot objectively reflect the choked condition of the filter under different circumstances. For improving the shortcoming, the dust quantity chocked on the filter is detected optically to inform users the replacement timing of the filter. However, the thickness and meshes of conventional filters made of sponge are hardly uniform, which results in a deviation of light signals received by a light receiver from different sections on the filter. Therefore, the dust quantity chocked on the filter and the replacement timing of the filter in the projector cannot be estimated accurately.

### SUMMARY OF THE INVENTION

It is therefore a primary objective of the claimed invention to provide an electronic device capable of detecting the timing for replacing a filter for solving the above-mentioned problem.

According to the claimed invention, an electronic device includes a housing comprising a vent, and a filter installed nearby the vent. The filter includes a first filter section made of a first material, and a second filter section made of a second material. The first material has better uniformity than the second material. The electronic device further includes a light emitter for emitting a light signal to the first filter section, a light receiver for receiving the light signal emitted from the light emitter, and a control unit installed electrically connected to the light receiver for operating the electronic device according to a receiving result of the light signal received by the light receiver.

According to the claimed invention, a filter device includes a filter having a first filter section made of a first material, and a second filter section made of a second material. The first material has better uniformity than second material. The filter device further includes a light emitter for emitting a light signal to the first filter section, and a light receiver for receiving the light signal emitted from the light emitter.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic drawing of an electronic device according to a preferred embodiment of the present invention.

FIG. 2 is a functional block diagram of the electronic device according to the preferred embodiment of the present invention.

FIG. 3 is a diagram illustrating relative positions of a filter, a light emitter, and a light receiver according to a first embodiment of the present invention.

FIG. 4 is a diagram illustrating relative positions of the filter, the light emitter, and the light receiver according to a second embodiment of the present invention.

### DETAILED DESCRIPTION

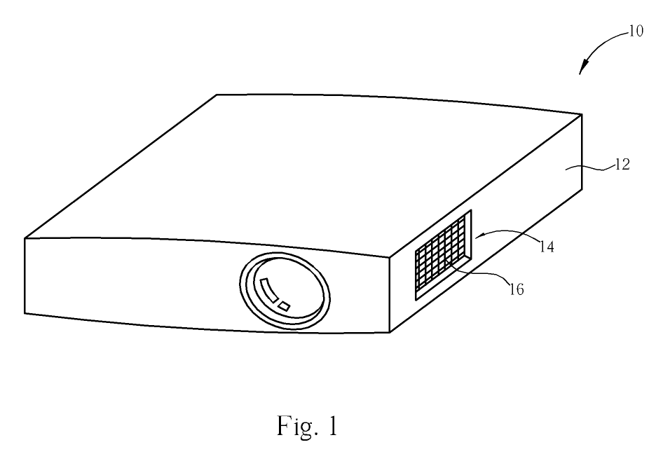

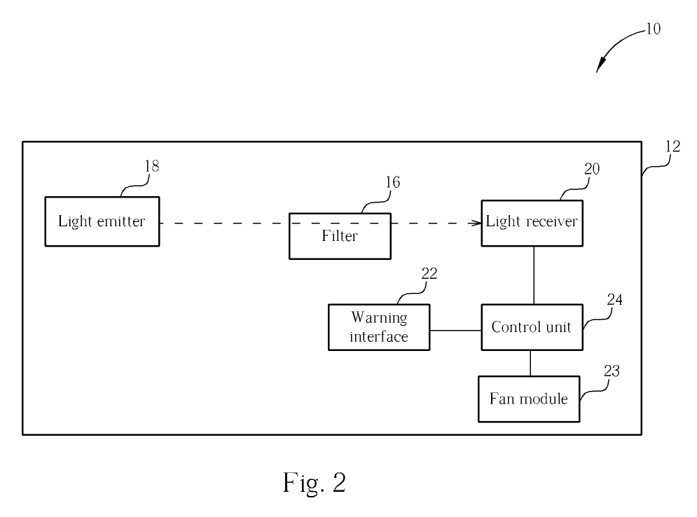

Please refer to FIG. 1 and FIG. 2. FIG. 1 is a schematic drawing of an electronic device 10 according to a preferred embodiment of the present invention. FIG. 2 is a functional block diagram of the electronic device 10 according to the preferred embodiment of the present invention. The electronic device 10 may be a projection device, such as a projector, a rear projection television, and so on. The electronic device 10 includes a housing 12 for covering inner components. A vent 14 is disposed on the housing 12 for discharging heat out of the electronic device 10, such as heat generated by lamps. The electronic device 10 further includes a filter 16 installed inside the housing 12 and nearby the vent 14 for preventing dust from getting into the electronic device 10. The electronic device 10 further includes a light emitter 18 installed inside the housing 12 for emitting a light signal to the filter 16, a light receiver 20 installed inside the housing 12 for receiving the light signal emitted from the light emitter 18, and a warning interface 22 for presenting a warning message so as to inform the user of replacing the filter 16. The warning interface 22 may be an illuminant for twinkling so as to present a visual warning message. The warning interface 58 also may be a speaker for outputting sound signals so as to present an audio warning message. The electronic device 10 further includes a fan module 23 for impelling the airflow inside the electronic device 10, and a control unit 24 installed inside the housing 12 and electrically connected to the light receiver 20, the warning interface 22, and the fan module 23 for controlling the warning interface 22 to present the warning message or for controlling the fan module 23 according to a receiving result of the light signal received by the light receiver 20. For example, when the light signal received by the light receiver 20 is less than a threshold, the control module 24 outputs an operation signal to the fan module 23 for increasing a rotational speed of the fan module 23, or the control module 24 outputs an operation signal to the warning interface 22 for controlling the warning interface 22 to present the warning message, such as turning on a red light. The control module 24 also may output the operation signal to the warning interface 22 for controlling the warning interface 22 to disable a message corresponding to a normal status, such as turning off a green light. In conclusion, when the dust quantity choked on the filter 16 is greater than a predetermined level so that the light signal received by the light receiver 20 is equal to or less than the threshold, the effect on filtering dust by the filter 16 is affected below a level. To clean/replace the filter 16 or to increase the rotational speed of the fan module 23 is necessary.

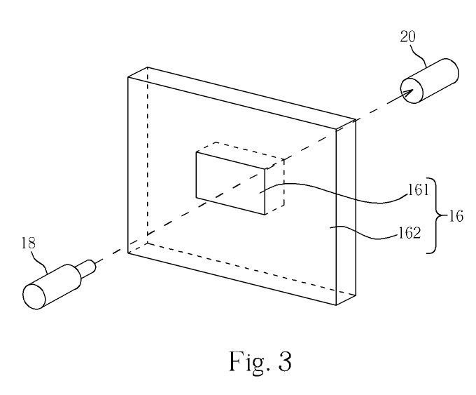

Please refer to FIG. 3. FIG. 3 is a diagram illustrating relative positions of the filter 16, the light emitter 18, and the light receiver 20 according to a first embodiment of the present invention. The filter 16 includes a first filter section 161 made of a first material, and a second filter section 162 made of a second material. The first material has better uniformity than the second material does. That is, the first material has better meshed uniformity than the second material, or the first material has better thickness uniformity than the second material. The first material may be metal mesh, plastic mesh, and so on. The second material may be sponge. In general, a thickness tolerance of the metal mesh is below 5 millimeters, so the metal mesh has better thickness uniformity than the sponge. The first filter section 161 of the filter 16 is disposed between the light emitter 18 and the light receiver 20. The light signal emitted from the light emitter 18 passes through the first filter section 161, and is received by the light receiver 20. The first filter section 161 made of the first material has better meshed uniformity or thickness uniformity, so that the problem of the deviation of received light signals due to inconsistency of material can be solved and the dust quantity chocked on the filter 16 can be estimated accurately. Outside the path of the light signal, the second filter section 162 is made of the second material (sponge) with better filter efficiency and lower cost than metal mesh or plastic mesh, so the filter 16 can block dust efficiently.

In the prior art, the entire filter 16 is made of the sponge. For instance, the light signal received by the light receiver corresponding to a threshold (20%) stands for the dust quantity chocked on the filter corresponding to a critical level (80% of filter porosity) in a conventional method of sensing the filter optically. The threshold in the present invention is preferably set as greater than that in the conventional method because the second material, such as the sponge, has better filter efficiency than the first material, such as metal mesh or plastic mesh. For example, if the threshold in the invention is set to 40%, that is, the light signal received by the light receiver 20 corresponds to the threshold (40%), it stands for the dust quantity chocked on the first filter section 161 corresponding to a level, such as 60% of porosity of the first filter section 161, and the dust quantity chocked on the second filter section 162 corresponding to the critical level, such as 80% of porosity of the second filter section 162. It is necessary to increase the rotational speed of the fan module 23 or to remind users to change the filter 16 of the electronic device 10.

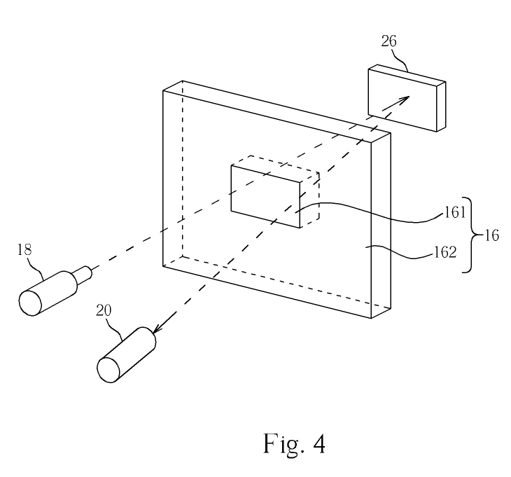

Please refer to FIG. 4. FIG. 4 is a diagram illustrating relative positions of the filter 16, the light emitter 18, and the light receiver 20 according to a second embodiment of the present invention. The difference between the first embodiment and the second embodiment is that the light emitter 18 and the light receiver 20 are disposed on a side of the first filter section 161 of the filter 16. The electronic device 10 further includes a reflector 26 installed on the other side of the first filter section 161. The reflector may be made of tinfoil. The light emitter 18 emits the light signal to the reflector 26 through the first filter section 161, and the reflector 26 reflects the light signal emitted from the light emitter 18 to the light receiver 20 through the first filter section 161 again. The first filter section 161 of the first material has better meshed or thickness uniformity so that the problem of the deviation of received light signals due to inconsistency of material can be solved and the dust quantity chocked on the filter 16 can be estimated accurately.

In contrast to the prior art, the present invention partially utilizes the material having better meshed or thickness uniformity, such as metal mesh or plastic mesh, to be sensed optically so that the problem of the deviation of received light signals due to inconsistency of material can be solved and the dust quantity chocked on the filter can be estimated accurately. In addition, outside the path of the light signal, adapting another filter section made of the material having poor meshed or thickness uniformity but better filter efficiency, such as the sponge, can reduce cost of the filter and block dust efficiently.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An electronic device comprising:
a housing comprising a vent;
a filter installed nearby the vent, the filter comprising:
a first filter section made of a first material; and
a second filter section made of a second material, the first material having better uniformity than the second material;
a light emitter for emitting a light signal to the first filter section;
a light receiver for receiving the light signal emitted from the light emitter; and
a control unit electrically connected to the light receiver for operating the electronic device according to a receiving result of the light signal received by the light receiver.

2. The electronic device of claim 1 wherein the control unit generates an operation signal when the receiving result is less than a predetermined value.

3. The electronic device of claim 2 further comprising a fan module electrically connected to the control module and the fan module receives the operation signal to increase a rotational speed of the fan module.

4. The electronic device of claim 2 further comprising a warning interface electrically connected to the control module and the warning interface receives the operation signal to present a warning message.

5. The electronic device of claim 4 wherein the warning interface is an illuminant.

6. The electronic device of claim 4 wherein the warning interface is a speaker.

7. The electronic device of claim 1 wherein the first material has better meshed uniformity than the second material.

8. The electronic device of claim 1 wherein the first material has better thickness uniformity than the second material.

9. The electronic device of claim 1 wherein the first material is metal mesh or plastic mesh.

10. The electronic device of claim 1 wherein the second material is a sponge.

11. The electronic device of claim 1 wherein the first filter section is disposed between the light emitter and the light receiver.

12. The electronic device of claim 1 further comprising a reflector installed on a first side of the first filter section wherein the light emitter and the light receiver are disposed on a second side of the first filter section and the reflector reflects the light signal emitted from the light emitter to the light receiver.

13. The electronic device of claim 12 wherein the reflector is made of tinfoil.

14. A filter device comprising:
a filter comprising:
a first filter section made of a first material; and
a second filter section made of a second material, the first material having better uniformity than second material;
a light emitter for emitting a light signal to the first filter section; and
a light receiver for receiving the light signal emitted from the light emitter.

15. The filter device of claim 14 wherein the first material has better meshed uniformity than second material.

16. The filter device of claim 14 wherein the first material has better thickness uniformity than second material.

17. The filter device of claim 14 wherein the first material is metal mesh or plastic mesh.

18. The filter device of claim 14 wherein the first filter section is disposed between the light emitter and the light receiver.

19. The filter device of claim 14 further comprising a reflector installed on a first side of the first filter section wherein the light emitter and the light receiver are disposed on a second side of the first filter section and the reflector reflects the light signal emitted from the light emitter to the light receiver.

20. The filter device of claim 19 wherein the reflector is made of tinfoil.
